(19) United States
(12) Patent Application Publication
(10) Pub. No.: US 2011/0005857 A1
(43) Pub. Date: Jan. 13, 2011

(54) EXHAUST SYSTEM AND CORRESPONDING CONNECTION DEVICE FOR AN ACTUATOR

(76) Inventors: Michael Pommerer, Uhingen (DE); Manfred Nicolai, Esslingen (DE); Michael Ihring, Ostfildern (DE); Jürgen Kobe, Nurtingen (DE)

Correspondence Address: MCGLEW & TUTTLE, PC, P.O. BOX 9227, SCARBOROUGH STATION, SCARBOROUGH, NY, 10510-9227, US

(21) Appl. No.: 12/831,498

(22) Filed: Jul. 7, 2010

(30) Foreign Application Priority Data
Jul. 10, 2009 (DE) 10 2009 032 553.0

(51) Int. Cl. F16L 41/00; F01N 1/00

(52) U.S. Cl. 181/212; 285/125.1

(57) ABSTRACT

A connection device (1) for an actuator (4) acting as an active exhaust muffler is provided for connection to at least one feeding pipe section (8) of an exhaust system (3) of an internal combustion engine, especially of a motor vehicle. A connection section (5) is arranged between the actuator (4) and an exhaust system-side connection area (2) for spacing the actuator (4) from the exhaust system (2). Skillful design measures are provided, which lead at least to a change in a flow cross section of the connection area (2) compared to at least the feeding pipe section (8), to make it is possible to improve the thermal uncoupling between the actuator (4) and the exhaust system (3) without compromising the acoustic connection of the actuator (4).

### CROSS REFERENCE TO RELATED APPLICATIONS

This application claims the benefit of priority under 35 U.S.C. §119 of German Patent Application DE 10 2009 032 553.0 filed Jul. 10, 2009, the entire contents of which are incorporated herein by reference.

### FIELD OF THE INVENTION

The present invention pertains to a connection device for an actuator acting as an active exhaust muffler and to an exhaust system with an active exhaust muffler connected by such a connection device.

### BACKGROUND OF THE INVENTION

To reduce the noise pollution of internal combustion engines, an exhaust muffler is nowadays arranged in an exhaust system of the internal combustion engine. This exhaust muffler may also be designed as an active exhaust muffler in the form of an actuator.

### SUMMARY OF THE INVENTION

With the invention, in the case of such an active exhaust muffler, the actuator is sufficiently thermally uncoupled from the exhaust system.

The object of the present invention is to provide an improved or at least different embodiment in a connection device for an actuator acting as an active exhaust muffler and in an exhaust system with an actuator connected by such a connection device and designed as an active exhaust muffler, which embodiment is characterized especially by improved thermal uncoupling of the actuator from the exhaust system.

The present invention is based on the general idea of connecting an actuator acting as an active exhaust muffler to an exhaust system of an internal combustion engine, especially of a motor vehicle, such that at least one change in a flow cross section is formed compared to at least one feeding pipe section in an exhaust system-side connection area, to which the actuator is connected with a connection section for spacing the actuator from the exhaust system. Better thermal uncoupling of the actuator from the exhaust system can be achieved due to such a change in the flow cross section in the exhaust system-side connection area, as a result of which it becomes possible to shorten the connection section. The acoustic efficiency of the actuator is in turn improved by the shortening of the connection section.

At least one change in the flow cross section is established in a preferred embodiment in the exhaust system-side connection area by expanding the exhaust system-side connection area compared at least to the feeding pipe section. The velocity of flow is reduced by such an expansion of the flow cross section in the area of the connection section, on the one hand, as a result of which the shedding of vortices is reduced, and, on the other hand, a flow resistance of the exhaust gas caused by the actuator designed as an active exhaust muffler is reduced by the expansion of the flow cross section. Furthermore, the gas exchange between the connection section and the exhaust system-side connection area is reduced by the expansion of the flow cross section, so that the connection section can be shortened owing to the improved thermal uncoupling of the actuator from the exhaust system.

The connection section is arranged at least partly parallel or at an acute angle to the exhaust system-side connection area in another preferred embodiment. The exhaust system-side connection area is designed especially as an oval or round double pipe. Expansion of the flow cross section of the connection area is brought about, on the one hand, and the gas exchange between the exhaust system-side connection area and the connection section is markedly reduced, on the other hand, by such a parallel connection of the connection section to the exhaust system-side connection area. As was also explained above, this leads to improved thermal uncoupling of the actuator from the exhaust system with the known advantages.

It is obvious that the above-mentioned features, which will also be explained below, can be used not only in the particular combination indicated but in other combinations or alone as well, without going beyond the scope of the present invention.

Preferred exemplary embodiments of the present invention are shown in the drawings and will be explained in more detail in the following description, where identical reference numbers designate identical or similar or functionally identical components. The various features of novelty which characterize the invention are pointed out with particularity in the claims annexed to and forming a part of this disclosure. For a better understanding of the invention, its operating advantages and specific objects attained by its uses, reference is made to the accompanying drawings and descriptive matter in which preferred embodiments of the invention are illustrated.

### BRIEF DESCRIPTION OF THE DRAWINGS

In the drawings:

FIG. 1 is a schematic sectional view showing an actuator connection to an exhaust system with an expansion of a flow cross section in an exhaust system-side connection area;

FIG. 2 is a schematic sectional view showing the exhaust system-side connection area with at least partial coverage of a connection opening of a connection section, which said connection opening opens into the exhaust system-side;

FIG. 3 is a schematic sectional view showing an exhaust system-side connection area with a narrowing of the flow cross section arranged in front of the connection opening;

FIG. 4 is a schematic sectional view showing an exhaust system-side connection area with a connection section arranged at least partly parallel to the exhaust gas flow direction; and

FIG. 5 is a schematic sectional view showing a cross section through an exhaust system-side connection area designed as a double pipe according to the invention.

### DESCRIPTION OF THE PREFERRED EMBODIMENTS

Referring to the drawings in particular, as is shown in FIG. 1, a connection device 1 has a connection area 2 of an exhaust system 3, to which an actuator 4 designed as an active exhaust muffler is connected via a connection section 5. The connection section 5 opens into the exhaust system-side connection area 2 via a connection opening 6. A feeding pipe section 8, which is arranged in front of the connection area 2 in relation to an exhaust gas flow direction 7, likewise opens into the connection area 2. Furthermore, connection area 2 is connected to an exhausting pipe section 9, which is arranged after the connection area 2 in the exhaust gas flow direction 7. Via the feeding pipe section 8 and the exhausting pipe section 9, the connection area can be built into an exhaust system 3 or the exhaust system-side connection area 2 is designed as part of an exhaust system 3 and actuator 4 is or can be connected fluidically to the connection area 2 via its connection section 5 by means of the connection opening 6. Connection section 5 is used to space the actuator 4 apart from the exhaust system 3. This spacing is necessary to ensure a necessary thermal uncoupling of actuator 4 from the hot exhaust gases of the exhaust system 3. However, the muffling action of actuator 4 increasingly deteriorates with increasing distance from the connection area 2 and hence with increasing length of the connection section 5. Hot exhaust gases flow through the exhaust system 3 during operation according to the exhaust gas flow direction 7. Vortex generation, which causes increased gas exchange between the connection section 5 and the connection area 2, may now develop in the area of the connection opening 6. Increased amount of hot exhaust gas of the exhaust system 3 enters the connection section 5 due to the vortex generation 10. The thermal uncoupling of actuator 4 from the exhaust system 3 is deteriorated by this vortex generation 10 and the gas exchange associated therewith. As a consequence of this, sufficient length of the connection section 5 shall be ensured.

However, the length of connection section 5 can be shortened without deterioration of the thermal uncoupling if the connection area 2 is provided with at least one change in a flow cross section of the exhaust gas compared to at least the feeding pipe section 8.

Such a change in the flow cross section is brought about by, e.g., an expansion 11 of connection area 2 in an embodiment according to FIG. 1. The velocity of flow of the exhaust gas in the connection area 2 decreases due to this expansion 11 of the exhaust system-side connection area 2. Vortex generation 10 is reduced, among others, as a result of this, especially in the area of connection opening 6. Furthermore, a reduction of flow noises and a reduction of the back pressure caused by the actuator 4 acting as an active exhaust muffler can be considered to be favorable. The gas exchange between connection area 2 and connection section 5 is also reduced due to the reduction of vortex generation 10, which leads to improved thermal uncoupling of actuator 4 from the exhaust system 3. It is now possible due to the improved thermal uncoupling to shorten connection section 5. However, the muffling action of actuator 5 is, in turn, improved by this shortening of connection section 5. Thus, several significant improvements of the connection device 1 can be implemented due to at least one change in the flow cross section, e.g., an expansion, in the connection area 2.

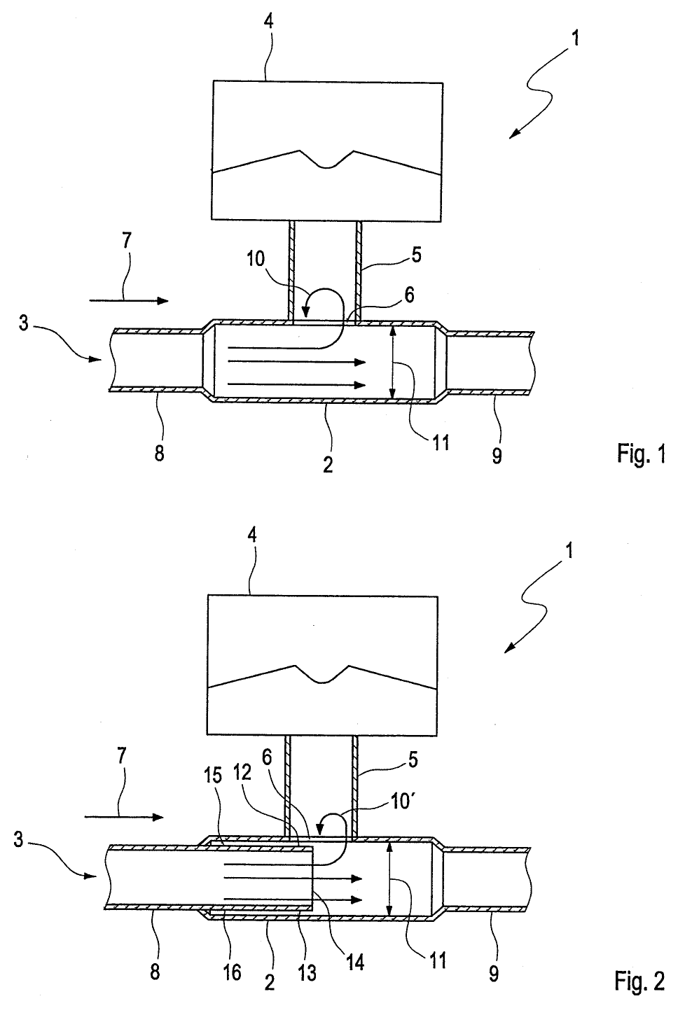

According to FIG. 2, the embodiment shown in FIG. 1 can be improved by a cover 12 arranged in the connection area. Cover 12 hides the connection opening 6 of connection section 5 at least partly, which said opening opens into the connection area 2.

Cover 12 is designed as a pipe section 13 in a preferred embodiment. This pipe section 13 may be made integrally or in one piece with at least the feeding pipe section of the exhaust system 3. Vortex generation 10′ is reduced by such a pipe section 13 in the area of connection section 5. The thermal uncoupling of the actuator 4 from the exhaust system 3 is further improved by this. Pipe section 13 has a passage opening 14 at its end protruding into the connection area 2. The plane defined by the passage opening 14 may point in the direction of connection section 5, in the direction of the exhausting pipe section 9 or towards an area located opposite the connection opening 6. More embodiments, which are favorable in terms of flow, can be designed hereby. For example, it is conceivable that the upper section 15 of pipe section 13 protrudes farther into the connection area 2 than the lower section 16 of the pipe section 13. The pipe section 13 protruding into the connection area 2 should be designed in this embodiment, for example, at least partly as a longitudinally halved half pipe, whose upper section 15 covers the connection opening 6 at least partly.

Pipe section 13 may also be formed continuously and integrally or in one piece with the feeding pipe section 8 and with the exhausting pipe section 9 of the exhaust system 3. It is especially advantageous in this case if the pipe section 13 arranged in the connection area 2 has at least one passage opening 14 but preferably a plurality of passage openings 14, which are, moreover, preferably arranged in an area of the pipe section 13 (on the periphery of the pipe section 13) facing away from the connection opening 6. The thermal uncoupling of the actuator 4 from the exhaust system 3 is also further improved by such an embodiment, without compromising the acoustic connection of the actuator 4.

Furthermore, it is conceivable in other embodiments to design the cover 12 independently from the feeding pipe section 8 and/or from the exhausting pipe section 9 within the connection area 2.

It shall be possible in all embodiments with a cover 12 for the cover 12 to be located at least partly at a spaced location from the plane of the connection opening 6 and/or for cover 12 to protrude at least partly into the circumferential region of the connection opening 6 (the cover 12 extends at least partially into a circumferential region of the connection opening 6 near to or spaced from the plane of the opening 6).

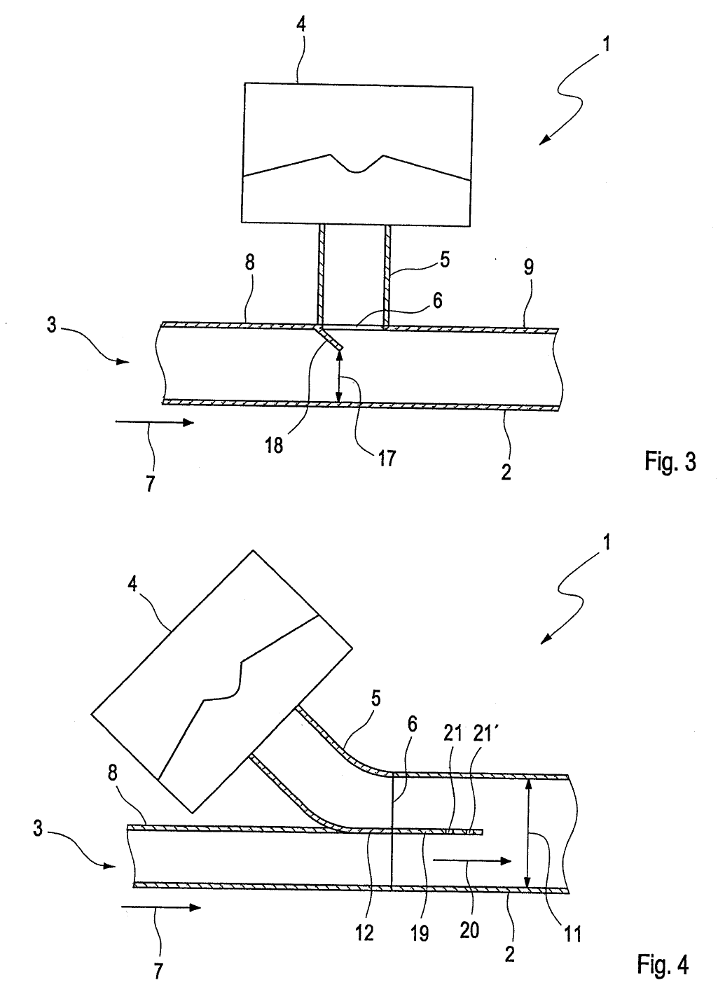

In another embodiment, a narrowing 17 of the flow cross section compared to at least the feeding pipe section 8 is formed in front of the connection opening 6 in the exhaust gas flow direction 7 in the connection area 2. This may be implemented, for example, as is shown in FIG. 3, by a kind of ramp 18, which can be positioned in front of the connection opening 6 in the exhaust gas flow direction 7 in the connection area. It is also possible, furthermore, to design the ramp as a continuous ramp in the circumferential direction, so that a kind of nozzle is formed. Vortex generation 10, 10′ at or in the connection section 5 is reduced by such a design measure as well. The angle formed by ramp 18 with the exhaust gas flow direction 7 can be optimized in respect to vortex generation 10 in the area of the connection section 5.

Connection section 5 is arranged at least partly parallel or at an acute angle to the exhaust gas flow direction 7 in another preferred embodiment, as is shown in FIG. 4. It is conceivable here that the at least partly parallel connection section 5 in the connection area 2 is separated at least partly from a main flow path 20 of the exhaust gas by a separating plate 19. To connect the connection section 5 fluidically to the connection area 2, it is advantageous to optionally provide the separating plate 19 with at least one recess 21, 21′.

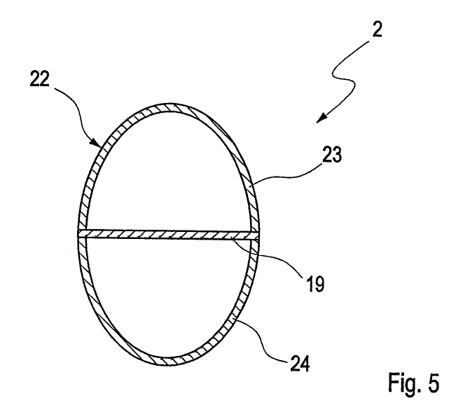

It is especially advantageous, as is shown in FIG. 5, to design the connection area 2 in the manner of an especially oval or round double pipe 22, wherein said double pipe 22 may be built of two D-shaped pipe halves 23, 24, between which a partition 19 may be arranged.

As was described above, this partition 19 may have recesses 21, 21′ to ensure that the connection section 5 of actuator 4, which section is connected to the first pipe half 23, is fluidically connected to the exhaust system 3 connected to the second pipe half 24. Excellent thermal uncoupling without any change in the good acoustic connection of the actuator 4 to the exhaust system 3 is likewise possible due to this parallel routing of the connection section 5 and of the main flow path 20 of the exhaust gas.

All the above-described design measures may also be combined with one another as desired in order to establish an optimal thermal uncoupling of actuator 4 from the exhaust system 3. Thus, it is conceivable that a double pipe according to FIG. 5 leads to an at least partial expansion 11 in the connection area 2. Such a design of the connection device 1 also leads to the cover 12 providing coverage of the connection opening 6, which is provided by partition 19. Furthermore, such an embodiment may be expanded by a ramp 18 according to FIG. 3. Thus, all design measures can be combined with one another in any desired manner as needed without going beyond the scope of the present invention.

An exhaust system with such a connection device 1 may be designed such that the actuator 4 designed as an active exhaust muffler has very good thermal uncoupling of the actuator 4 from the exhaust system 3 at reduced length of the connection section 5, without the muffling action of the actuator being compromised.

Furthermore, at least some of the above-described design measures make it possible to reduce the flow noise. A reduction of the flow resistance or back pressure caused by the actuator 4 designed as an active exhaust muffler can also be achieved by at least some of the design measures.

While specific embodiments of the invention have been described in detail to illustrate the application of the principles of the invention, it will be understood that the invention may be embodied otherwise without departing from such principles.

What is claimed is:

1. A connection device for an actuator acting as an active exhaust muffler for connection to at least one feeding pipe section of an exhaust system of an internal combustion engine, the connection device comprising:
an exhaust system-side connection area connected to the feeding pipe section; and
a connection section arranged between the actuator and the exhaust system-side connection area for spacing the actuator from the exhaust system, the exhaust system-side connection area having at least one change of a flow cross section compared at least to the feeding pipe section.

2. A connection device in accordance with claim 1, wherein the exhaust system-side connection area has an expansion of the flow cross section compared to at least the feeding pipe section.

3. A connection device in accordance with claim 1, further comprising: a cover, wherein:
the connection section has a connection opening, opening into the exhaust system-side connection area;
the cover is arranged in the exhaust system-side connection area; and
the cover at least partly covers the connection opening of the connection section.

4. A connection device in accordance with claim 3, wherein the cover is located at least partly at a spaced location from the connection opening.

5. A connection device in accordance with claim 3, wherein the cover protrudes at least partly into the connection opening.

6. A connection device in accordance with claim 3, wherein the cover comprises a pipe section.

7. A connection device in accordance with claim 6, wherein the pipe section is made integrally or in one piece at least with the feeding pipe section of the exhaust system.

8. A connection device in accordance with claim 6, wherein the pipe section is made integrally or in one piece with the feeding pipe section of the exhaust system and with an exhausting pipe section of the exhaust system.

9. A connection device in accordance with claims 6, wherein the pipe section has at least one passage opening.

10. A connection device in accordance with claim 9, wherein the at least one passage opening is oriented towards the connection opening or is arranged at the pipe section in an area opposite the connection opening.

11. A connection device in accordance with claim 1, wherein a narrowing of the flow cross section is arranged in the exhaust system-side connection area, in front of the connection opening with respect to an exhaust gas flow direction.

12. A connection device in accordance with claim 1, wherein the connection section is arranged at least partly parallel or at an acute angle to the exhaust gas flow direction.

13. A connection device in accordance with claim 1, wherein the exhaust system-side connection area is designed as an oval or round double pipe.

14. A connection device in accordance with claim 13, wherein the double pipe has two pipe halves and at least one recess in a partition arranged between the two pipe halves.

15. A motor vehicle internal combustion engine exhaust system comprising:
a feeding pipe section;
an actuator comprising an active exhaust muffler;
an exhaust system-side connection area connected to the feeding pipe section; and
a connection section arranged between the actuator and the exhaust system-side connection area for spacing the actuator from the exhaust system, the exhaust system-side connection area having at least one change of a flow cross section compared to the feeding pipe section.

16. A connection device in accordance with claim 15, wherein the change of a flow cross section of the exhaust system-side connection area is an expansion of the flow cross section compared to the flow cross section of the feeding pipe section.

17. A connection device in accordance with claim 16, further comprising: a cover, wherein:
the connection section has a connection opening, opening into the exhaust system-side connection area;
the cover is arranged in the exhaust system-side connection area; and
the cover at least partly covers an extent of the connection opening of the connection section.

18. A connection device in accordance with claim 17, wherein the cover comprises a pipe section.

19. A connection device in accordance with claim 16, wherein the connection section is arranged at least partly parallel or at an acute angle to the exhaust gas flow direction.

20. A connection device in accordance with claim 16, wherein the exhaust system-side connection area is designed as an oval or round double pipe.
